(19) United States
(12) Patent Application Publication
(10) Pub. No.: US 2015/0169583 A1
(43) Pub. Date: Jun. 18, 2015

(54) TRENDING ANALYSIS FOR STREAMS OF DOCUMENTS

(71) Applicant: Attivio, Inc., Newton, MA (US)

(72) Inventor: John O'Neil, Watertown, MA (US)

(73) Assignee: ATTIVIO, INC., Newton, MA (US)

(21) Appl. No.: 14/133,367

(22) Filed: Dec. 18, 2013

(51) Int. Cl. G06F 17/30

(52) U.S. Cl. CPC G06F 17/3053

(57) ABSTRACT

An event of interest is identified as trending if the number of occurrences of the event in a stream of documents is increasing or decreasing significantly from normal levels. Such a determination is made by comparing a number of occurrences in a recent time period to a long term average. An average number of occurrences over a given time period, and its variance, can be computed from historical information. The current number of occurrences also is computed for the most recent time period. Events, for which the current number is significantly different from the average level, by considering the variance, have statistically significant changes.

### BACKGROUND

With the proliferation of content on computer networks it is increasingly useful to have a variety of ways of understanding and organizing content. It is common to understand and organize content by topic, author, relevance, popularity, date, etc. There also is an increasing interest in automated tools that attempt to discern the attitude or sentiments of the author toward the subject of the document, such as whether these attitudes are positive, negative or neutral, and how strong these attitudes or sentiments are. For example, one might want to locate strongly positive reviews of a movie or travel destination.

There are several techniques for processing documents to determine if sentiments expressed in a document are positive or negative. In general, the techniques involve using documents with associated sentiment judgments, and from those documents learning to associate words and phrases with a sentiment magnitude and polarity. Then, phrases are identified in a document, and then the document is scored based on the sentiment magnitudes and polarities found in the document. There are a variety of computational techniques to achieve these results. These techniques are commonly used for scoring an entire document, although they can be extended to scoring sentences within a document by treating each sentence as if it were a distinct document.

There also are several techniques for processing documents to find names of different kinds of individual entities (most commonly personal names, geographical names, and organization names) in a document. In general, the techniques involve either looking for occurrences of names from a list within a document, or searching the document to find a set of contexts and features that statistically predict where the names of entities are located in the document. Each entity in the document can be associated with a label from the set of labels found in the annotated training corpus. There are a variety of computational techniques for identifying entities in documents.

In addition to identifying various ways of understanding and organizing content, there is an increasing interest in tools that help understand trends in real-time streams of content, such as news feeds, search queries, social media activity, and business data. Commonly used tools today primarily solve the problem of identifying what is most popular or what is becoming popular, by simply counting the number of occurrences of an item over time, such as by identifying the top search terms used in an hour, day or week, the number of occurrences of a topic in social media activity in the last hour, and changes in those numbers of occurrences from one time period to the next. Colloquially, these topics are either becoming “hot” or “not”.

### SUMMARY

This Summary introduces selected concepts in a simplified form that are described further below in the Detailed Description. This Summary is intended neither to identify key or essential features of the claimed subject matter, nor to be used to limit the scope of the claimed subject matter.

Identifying what is most popular, or becoming popular, or losing popularity, is not the same problem as identifying whether the occurrences of an event of interest in a stream of content are increasing or decreasing significantly from normal levels, or predicting that such a change in the occurrences of an event is likely to occur. This problem is particularly difficult when the number of occurrences in any period of time is low and the variability of that number of occurrences from one period of time to the next appears to be significant. Defining a trend in sequences of events, where some events are rare and others are frequent, can be challenging.

The kinds of events of interest to be identified in the stream of documents also may be more complex than the mere mention of keyword stem in a search query, or a celebrity's name, a brand name or an event in news articles and the like. Some examples of interesting trends are a change in sentiment associated with an entity, and co-occurrences of entities in the same document. In other words, the event of interest for which trending information is desired can be co-occurrences of two or more events in the same document.

To determine whether the number of occurrences of an event of interest in a stream of content is increasing or decreasing significantly from normal levels, first the “normal” level is determined. For example, an average number of occurrences in a given time period, and it variance, can be computed from historical information. The current level then is computed, which is the actual number of occurrences in the most recent time period. Events, for which the current level is significantly different from the average level, by considering the variance, have statistically significant changes.

When computing the long-term average and variance, the occurrences of the event of interest can be modeled statistically. In one implementation the occurrences of an event of interest can be modeled as a process with a Poisson distribution. A Poisson distribution is suitable because events being modeled are discrete, positive values, and such a distribution can effectively model probabilistic events with low counts over time. Other probability distribution functions that model discrete, positive values also can be used.

When implemented in a large scale document processing system that processes streams of documents, the long term average and current counts for various facets in an index can be updated as each document is processed, thus allowing trending scores for each facet to be computed as documents are indexed. Such processing allows for real-time insights into trends as they are occurring.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of an example document processing system in which a trending analysis can be performed.

FIG. 2 is a data flow diagram illustrating an example implementation of trending analysis.

FIG. 3 is a flow chart describing an example operation of trending analysis in FIG. 2.

FIG. 4 is a block diagram of an example computing device in which modules of such a system can be implemented.

### DETAILED DESCRIPTION

The following section provides an example operating environment in which a document processing system with trending analysis can be implemented.

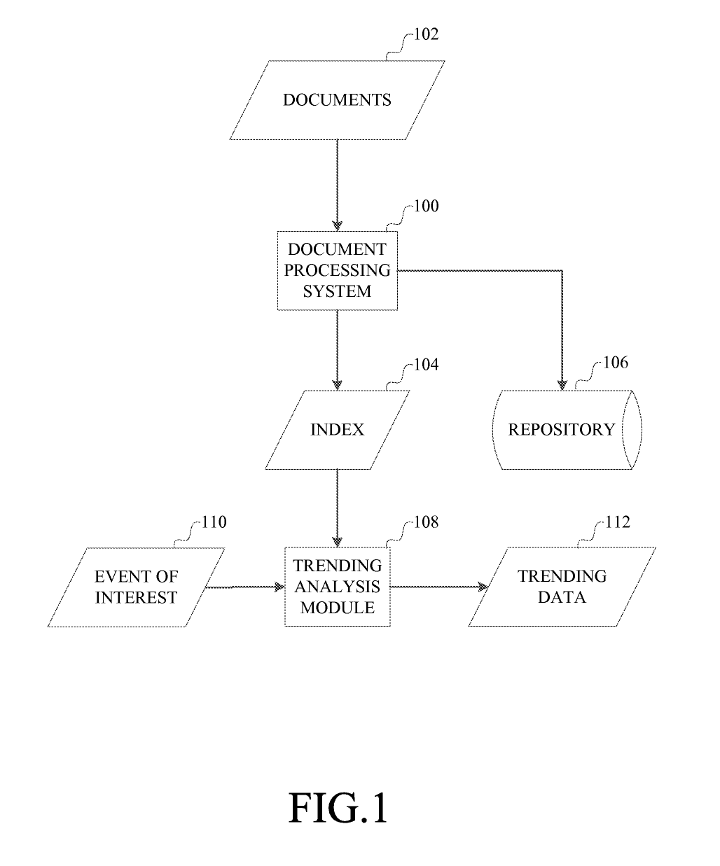

Referring to FIG. 1, a document processing system 100 includes one or more processing nodes (not shown) that receive and process a stream of documents 102. The documents are received from a variety of sources (not shown). A document can be any data in electronic form, and can include structured or unstructured content, and which can be indexed. A source can be any data source that provides a stream of documents. The document processing system 100 processes each document 102 to add data to an index 104 of the received documents. The received documents are stored in a repository 106. Such a system allows users to query the index and access the documents stored in the repository 106.

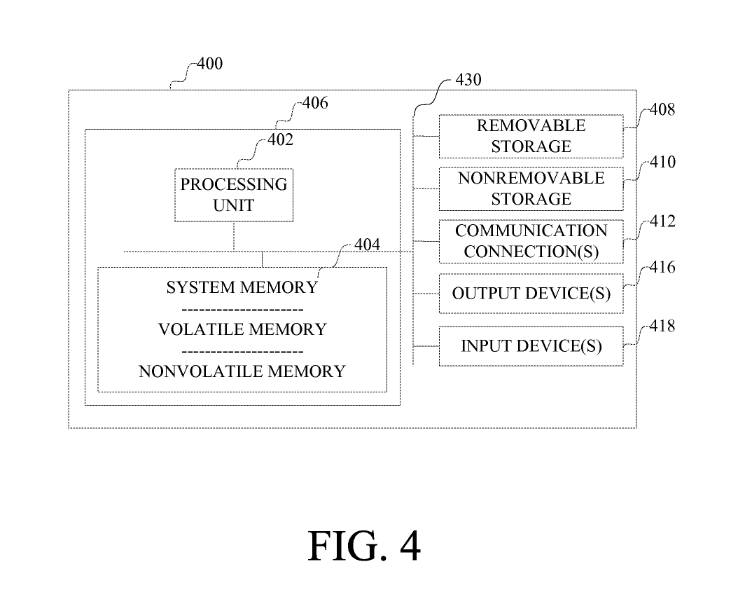

Each processing node and other module in the data processing system is a computer that is configured to perform various processing operations by a computer program executed on the computer. Such computers generally are of the form described in FIG. 4 below.

The repository 106 includes, at least, one or more storage devices accessible by processing nodes of the data processing system to store data. Such storage devices can be configured to be accessed directly by other computers or can be accessed through a server computer (not shown) over a computer network. Such a server computer also is a computer that is configured to perform various data retrieval, storage and management operations on the storage devices, and generally takes the form of a computer as described in FIG. 4 below.

The index 104 stores, for each received document, values for a number of different fields. These values are identified by processing the received documents. The relevant fields contain data associated with the document: document metadata, words, phrases, or properties extracted from the document via statistical analysis or machine learning, or information mined from the document. Thus, for each document, the data processing system identifies, for each field, one or more values for that field for the document. Each discrete element that is extracted or otherwise identified for a document is a field value and is added as a field value. For example, each entity identified in a document is stored as a field value for an entity field for the document. In an example implementation, such processing results in one or more triples of {document identifier, field identifier, field value}. This information is stored in an index that maps a {field identifier, field value} pair to one or more document identifiers. The document identifiers can be used to retrieve the corresponding document from the repository 106. Each document identifier also can have (or can include) a time stamp indicating a date and time on which the document was received and processed by the system. The count of the number of documents for a specific {field identifier, field value} pair also can be stored. Each {field identifier, field value} pair is a called a facet, and each facet can have a number of counts associated with it.

The index 104 is accessed by a trending analysis module 108. The trending analysis module accesses data from the index 104 to determine how a particular event of interest 110 is trending, or how multiple events of interest are trending, to provide trending data 112. An event is an occurrence of a field value in a field, or a combination of field values in one or more fields, for a document. A combination of field values can be defined by any kind of mathematical or logical operation, such as a Boolean or other matching operation, performed on the field values of documents. For example, an event can be the occurrence of an entity name in an entity field of a document. Another example of an event is the co-occurrence of an entity name in an entity field and a sentiment in a sentiment field in a document, or the co-occurrence of one entity name in an entity field for a document and another entity name in an entity field for the document. Thus the trending analysis module processes counts of events occurring in multiple documents as those documents are processed by the system over time.

The trending data 112 can be provided to any other system, program, application or other component on a computer system to be used to access the repository 106. In particular, given an event of interest identified as trending, the document identifiers of documents matching that trend can be identified using the index. A user or other application can use this information for a variety of purposes.

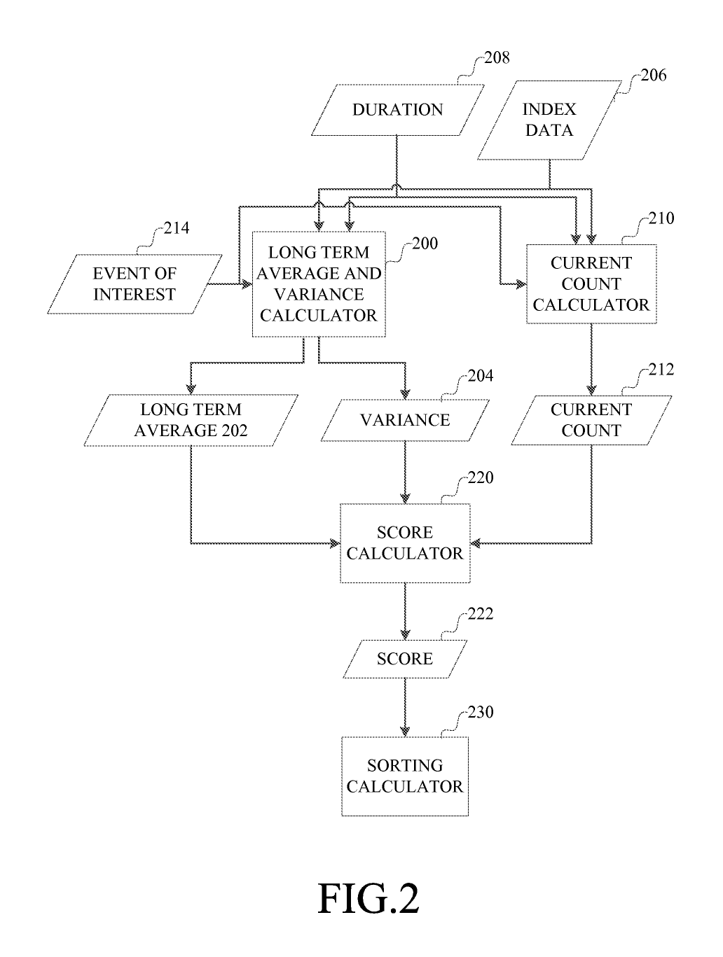

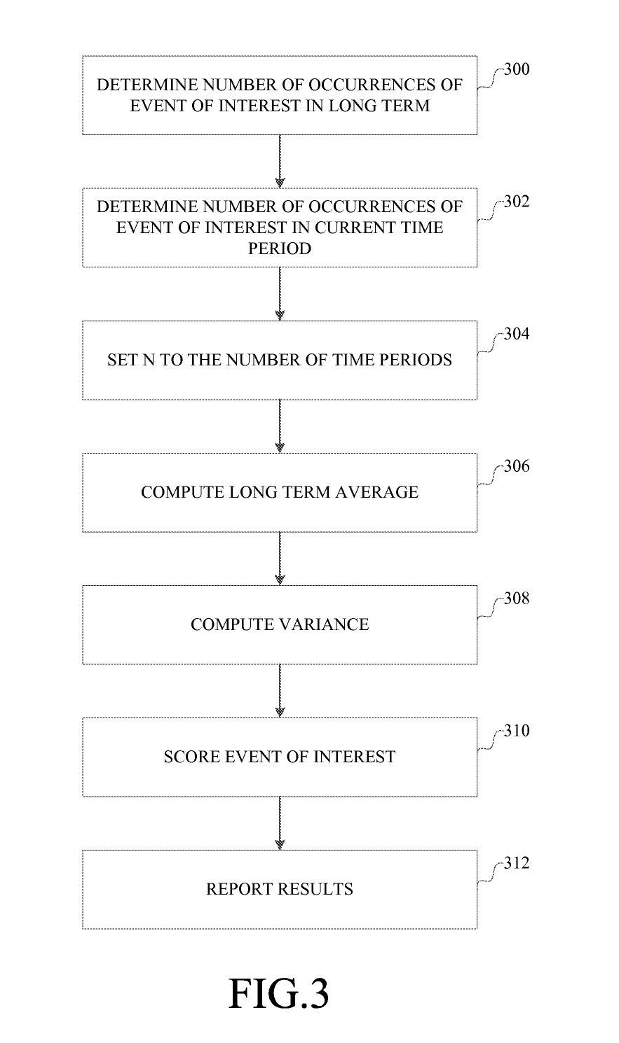

Given this context, an example implementation will be described in more detail in connection with FIGS. 2-3.

In FIG. 2, a data flow diagram illustrates an example implementation of trending analysis. Given the index data 206, a long-term average and variance calculator 200 computes a long-term average 202 and long-term variance 204 for the number of occurrences of events of interest 214 in the documents processed by the system, based on a duration 208. A current count calculator 210 computes the current count 212 of the number of occurrences of events of interest 214 in the documents processed by the system with the current time frame defined by duration 208, which can be a user or system selectable parameter.

Given the long-term average, variance and current count, a score calculator 220 determines a score 222 for the event of interest. The score for each event of interest can be, for example, a function of the difference between its current count and the long-term average. In one implementation, the score for an event of interest is defined by how many standard deviations the current count of the number of occurrences of the event of interest is above the long-term average number of occurrences for that event of interest. A sorting calculator 230 can then sort, or rank, the events of interest based on their scores. The events of interest with the highest score are those that have a number of occurrences that has significantly increased in the current period of time compared to the long-term average. Even if only one event of interest is analyzed, its score is indicative of the difference in the number of occurrences of that event of interest in the current period of time compared to the long-term average.

Referring now to FIG. 3, a flow chart describing operation of this example implementation of trending analysis will now be described.

The number of occurrences for the event of interest over the long-term is determined 300. The number of occurrences for the current time period also is determined 302. A value n is set 304 to be the number of time periods, of the same duration as the current time period, that have occurred since the date of the first document that was processed. For example, if the current time period is one week and the first document was processed two years ago, then n is 104 (two years with 52 weeks per year).

Next, the long-term average is computed 306. This value is the number of occurrences of the event of interest over the long term divided by the number of time periods n. This value is the maximum likelihood lambda parameter of a Poisson distribution describing the frequency of occurrences of the event of interest. Next, the variance is computed 308, which is the lambda parameter.

Each event of interest is then scored 310, e.g., by determining the number of standard deviations each item is above its long-term average. The score itself, or a ranked ordering of events of interest based on their scores, or other result may then be reported 312. Such reporting can take the form of, for example, storing the results in a repository (e.g., repository 106 in FIG. 1), presenting a graphical representation of the information in a graphical user interface, and the like.

As an example, assume a first name occurs 100 times over the long term, and there are 10 time periods. In the current time period, the first name occurs 20 times. The lambda parameter is 100/10=10, as is the variance. The number of standard deviations for this event of interest in the current time period is (20−10)/10=1. Assume a second name occurs 10000 times over the long term, and the second name occurs 1100 times in the current time period. The lambda parameter is 10000/10=1000, as is the variance. The number of standard deviations of 1100 above the average of 1000 is (1100−1000)/1000=0.1. Thus, the first name is scored (1) higher than the second name is scored (0.1), notwithstanding the fact that the second name has both a greater overall count as well as an absolute greater increase in the current time period. However, when each name's count is measured by its variance, the first name's count in the current time period is shown to be much more exceptional, and thus more surprising, than the second's.

Thus, in one implementation a formula representing this kind of trending analysis has the form of:

(Current count of event−long term average count of event)/standard deviation of event, or:

[X_{iNc}−{(Σₓ₌₀^{N}X_{iNx})/N}]÷standard deviation of i,

where, for an event i, X_{iNx} is the number Xᵢ of occurrences of event i in documents arriving during each time period Nₓ, N is the number of time periods, and X_{iNc} is the number Xᵢ of occurrences of event i in documents arriving during the current time period N_{c}.

Such trending analysis can be tunable, i.e., the various parameters of the trending analysis can be modified and set by a user or by an application. For example, the duration of a time period, and a number N of time periods, can be changed efficiently, because the query for a (comparatively short) time period has far fewer name-count pairs than the query for the entire repository. The global name-count pairs can be stored very efficiently using a count-min hash or similar probabilistic data structure. It is also possible to identify “anti-trending” as well as “trending” items, by looking for events of interest with a substantial decrease in occurrence. One might also identify transitions in such trending data, from an increase to a decrease or vice versa.

The trending analysis module also can be used as part of a document processing pipeline so that information used for trending analysis is extracted and updated for each document that is processed. For example, when a document is processed, each a count for each facet is updated. A count for a current period of time, and a total count over time, for the facet can be updated, in turn allowing a trending score for that facet to be updated. A running score thus can be updated for each facet as documents are being added to the system on a regular basis. Facets with scores indicating a significant change in the number of occurrences can be identified and reported within the system.

Having now described an example implementation, a computer with which components of such a system can be implemented will now be described. The following description is intended to provide a brief, general description of a suitable computer with which one or more components of a system, such as shown in FIGS. 1 and 2, can be implemented. Examples of computers that may be suitable include, but are not limited to, personal computers, server computers, laptop or notebook computers, tablet computers, multiprocessor systems, microprocessor-based systems, minicomputers, mainframe computers, distributed computing environments that include any of the above systems or devices, and the like.

FIG. 4 illustrates a block diagram of an example of a suitable computer, and is not intended to suggest any limitation as to the scope of use or functionality of such a computer. With reference to FIG. 4, an example computer 400, in its most basic configuration illustrated by dashed line 406, includes at least one processing unit 402 and memory 404 interconnected by an interconnection mechanism such as one or more buses 430. The computer may include multiple processing units and/or additional co-processing units such as a graphics processing unit. Memory 404 may be volatile (such as RAM), non-volatile (such as ROM, flash memory, etc.) or some combination of the two. Additionally, computer 400 may include additional storage (removable and/or non-removable) including, but not limited to, magnetic or optical disks or tape. Such additional storage is illustrated in FIG. 4 by removable storage 408 and non-removable storage 410.

A computer storage medium may be part of or connected to computer 400. A computer storage medium is a medium in which information can be written to an addressable physical location for storage in the storage medium, retained in that physical location and retrieved from that physical location through a computer 400. Computer storage media includes volatile, nonvolatile and persistent computer storage media, and removable and non-removable computer storage media. Memory 404, removable storage 408 and non-removable storage 410 are all examples of computer storage media. Some examples of computer storage media are RAM, ROM, EEPROM, flash memory or other memory technology, CD-ROM, digital versatile disks (DVD) or other optically recorded or read storage, magnetic cassettes, magnetic tape, magnetic disk storage or other magnetic storage devices.

Computer 400 also may include communications connection(s) 412 that allow the device to communicate with other devices over a communication medium. A communication medium carries data between two points in a propagated signal. The communication connection 412 is a device that interfaces with the communication medium to send and transmit data through the communication medium. By way of example, and not limitation, communication media includes wired media such as a wired network or direct-wired connection, and wireless media such as acoustic, RF, infrared and other wireless media.

The computer 400 may have various input device(s) 414 such as a keyboard, mouse, pen, camera, touch input device, and so on. Output device(s) 416 such as a display, speakers, a printer, and so on may also be included. All of these devices are well known in the art and need not be discussed at length here.

The various additional components in FIG. 4 are generally interconnected and are connected with the processor and memory by an interconnection mechanism, such as one or more buses 430.

The various components of a system such as described above may be implemented on such a computer using software, including computer-executable instructions and/or computer-interpreted instructions, such as program modules, being processed by a computing machine. Generally, program modules include routines, programs, objects, components, data structures, and so on, that, when processed by a processing unit, instruct the processing unit to perform particular tasks or implement particular abstract data types. This system may be practiced in a distributed computing environment where tasks are performed by remote processing devices that are linked through a communications network. In a distributed computing environment, program modules may be located in both local and remote computer storage media including memory storage devices.

It should be understood that the subject matter defined in the appended claims is not necessarily limited to the specific implementations described above. The specific implementations described above are disclosed as examples only.

What is claimed is:

1. A computer-implemented process comprising:
storing data in a storage medium describing an index of a plurality of documents, each document having an associated time, wherein the index includes, for a plurality of fields, a plurality of field values and indicia of documents having the field values;
given a duration of time and an event of interest defined by one or more selected field values, determining with a processor a long-term average and a variance of a number of documents having the event of interest in the duration of time;
determining with the processor a current number of documents having the event of interest in a current time period having the given duration; and
computing with the processor a score for the event based on a comparison of the current number and the long-term average.

2. The computer-implemented process of claim 1, further comprising:
repeating steps of determining a long term average, determining a current number and computing a score for multiple events of interest; and
ranking the events of interest according to their computed scores.

3. The computer-implemented process of claim 1, wherein the event of interest is defined by a co-occurrence of a first selected field value and a second selected field value in a document

4. The computer-implemented process of claim 1, wherein computing a score comprises calculating a function of the form of:
(Current count of event−long term average count of event)/standard deviation of event.

5. The computer-implemented process of claim 1, wherein determining a long term average for an event of interest is performed when a document with the event of interest is processed.

6. The computer-implemented process of claim 5, wherein determining a current number of documents for an event of interest is performed when a document with the event of interest is processed.

7. The computer-implemented process of claim 6, wherein computing a score for an event of interest is performed when a document with the event of interest is processed.

8. An article of manufacture comprising:
a computer storage medium having computer program instructions stored on the computer storage medium which, when read from the computer storage medium and processed by a processor, instruct the processor to perform a process comprising:
accessing data in a storage medium describing an index of a plurality of documents, each document having an associated time, wherein the index includes, for a plurality of fields, a plurality of field values and indicia of documents having the field values;
given a duration of time and an event of interest defined by one or more selected field values, determining with a processor a long-term average and a variance of a number of documents having the event of interest in the duration of time;
determining with the processor a current number of documents having the event of interest in a current time period having the given duration; and
computing with the processor a score for the event based on a comparison of the current number and the long-term average.

9. The article of manufacture of claim 4, wherein the process further comprises:
repeating steps of determining a long term average, determining a current number and computing a score for multiple events of interest; and
ranking the events of interest according to their computed scores.

10. The article of manufacture of claim 4, wherein the event of interest is defined by a co-occurrence of a first selected field value and a second selected field value in a document.

11. The article of manufacture of claim 1, wherein computing a score comprises calculating a function of the form of:
(Current count of event−long term average count of event)/standard deviation of event.

12. The article of manufacture of claim 1, wherein determining a long term average for an event of interest is performed when a document with the event of interest is processed.

13. The article of manufacture of claim 5, wherein determining a current number of documents for an event of interest is performed when a document with the event of interest is processed.

14. The article of manufacture of claim 6, wherein computing a score for an event of interest is performed when a document with the event of interest is processed.

15. A computer system, comprising:
a long-term average computation module, accessing an index of a plurality of documents stored in a storage medium, each document having an associated time, wherein the index includes, for a plurality of fields, a plurality of field values and indicia of documents having the field values, having an input for receiving a duration of time and an event of interest defined by one or more selected field values, and an output providing a long-term average and a variance of a number of documents having the event of interest in the duration of time;
a scoring calculator receiving a current number of documents having the event of interest in a current time period having the given duration and the long-term average and providing as an output a score for the event based on a comparison of the current number and the long-term average.

16. The computer system of claim 15, wherein the event of interest is defined by a co-occurrence of a first selected field value and a second selected field value in a document.

17. The computer system of claim 15, wherein the scoring calculator computes a function of the form of:
(Current count of event−long term average count of event)/standard deviation of event.

18. The computer system of claim 15, wherein the long term average computation module processes an event of interest when a document with the event of interest is processed.

19. The computer system of claim 18, wherein a current number of documents for an event of interest is determined when a document with the event of interest is processed.

20. The computer system of claim 19, wherein a score for an event of interest is provided by the scoring calculator when a document with the event of interest is processed.
